(19) United States
(12) Patent Application Publication
(10) Pub. No.: US 2014/0043151 A1
(43) Pub. Date: Feb. 13, 2014

(54) BICYCLE WIRELESS INDICATING MODULE AND WIRELESS WARNING SYSTEM HAVING WIRELESS INDICATING MODULE

(71) Applicant: Miao-Ting LIN, New Taipei City (TW)

(72) Inventor: Miao-Ting LIN, New Taipei City (TW)

(73) Assignee: LAN ACCESSORIES CO., LTD.

(21) Appl. No.: 13/570,427

(22) Filed: Aug. 9, 2012

(51) Int. Cl. B62J 6/00

(52) U.S. Cl. 340/432

(57) ABSTRACT

A bicycle wireless indicating module for performing registration at a wireless control module of a wireless warning system is disclosed. The bicycle wireless indicating module receives and records a central control code of the wireless control module. When the wireless indicating module receives a coming control signal, the wireless indicating module matches if the coming control signal is in accordance with the recorded central control code. If yes, the wireless indicating module switches their indicating unit based on the received control signal, and forwards the control signal outbound. Thus, when a plurality of wireless indicating modules all records the central control code of the same wireless control module, the wireless control module is able to simultaneously control wireless indicating modules in the wireless warning system.

### BACKGROUND OF THE INVENTION

1. Field of the Invention

The present invention relates to warning systems of bicycles, in particular, it relates to a wireless warning system for transmitting control signals via a wireless transmission interface.

2. Description of Prior Art

As the environmental awareness rises, people start to highly concern about energy saving and carbon reduction. Accordingly, biking becomes a new trend of biking around the globe.

Generally speaking, in order to improve security of biking, bikers usually install lamp fixtures on bicycles to provide lighting. The lights from the lamp fixtures are used for providing warnings to draw attentions of passengers and other vehicle drivers when biking in a dim environment aiming to lower the accident rates.

Nonetheless, the functions offered by current bicycles lamp fixtures are limited. Bikers are demanding more functions other than providing warning effects.

### SUMMARY OF THE INVENTION

The purpose of the present invention is to provide a bicycle wireless indicating module, and a wireless warning system having wireless indicating module, wherein a single wireless control module of the wireless warning system is able to simultaneously control all wireless indicating module in the system.

In order to achieve the above objective, the wireless indicating module of the invention performs registration in a wireless control module of a wireless warning system. The wireless indicating module receives and records the central control code of the wireless control module. When the wireless indicating module receives incoming an incoming control signal, the wireless indicating module matches of the control signal is in accordance with the recorded central control code. If the matching passes, the wireless indicating module switches their indicating unit based on the received control signal and forwards the control signal outbound.

Compare with the related art, the advantage of the present invention is that a user is allow to control the wireless indicating module to perform registration at the wireless control module before using, and control the wireless indicating module to receive and record the central control code of the wireless control module where the registration takes place. The advantage is that when a biking team uses the wireless warning system of the present invention, as long as all the bikers in the team control to perform registration of their wireless indicating modules at the wireless control module of the leading bicycle. The biker of the leading bicycle is able to simultaneously control all wireless indicating modules via the wireless control module of the leading bicycle in order to resolving the difficulty where the bikers at the back of the team are not able to know the status of the wireless indicating module and not informed of the coming actions such as turning directions left or right or stop cycling.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a schematic diagram of a preferred embodiment according to the present invention before installing a wireless control assembly;

FIG. 2 is a schematic diagram of a preferred embodiment according to the present invention after installing a wireless control assembly;

FIG. 3 is a block diagram of a wireless control assembly of a preferred embodiment according to the present invention;

FIG. 4 is a registration schematic diagram of a preferred embodiment according to the present invention;

FIG. 5 is a registration flow chart of a preferred embodiment according to the present invention;

FIG. 6 is a control flow chart of a preferred embodiment according to the present invention;

FIG. 7 is a schematic diagram for forwarding control signals of a preferred embodiment according to the present invention; and

FIG. 8 is a schematic diagram for forwarding control signals of the other preferred embodiment according to the present invention.

### DETAILED DESCRIPTION OF THE INVENTION

Embodiments are provided in the following in order to further detail the implementations of the present invention in the summary. It should be noted that objects used in the diagrams of the embodiments are provided with proportions, dimensions, deformations, displacements and details are examples and the present invention is not limited thereto and identical components in the embodiments are the given same component numbers.

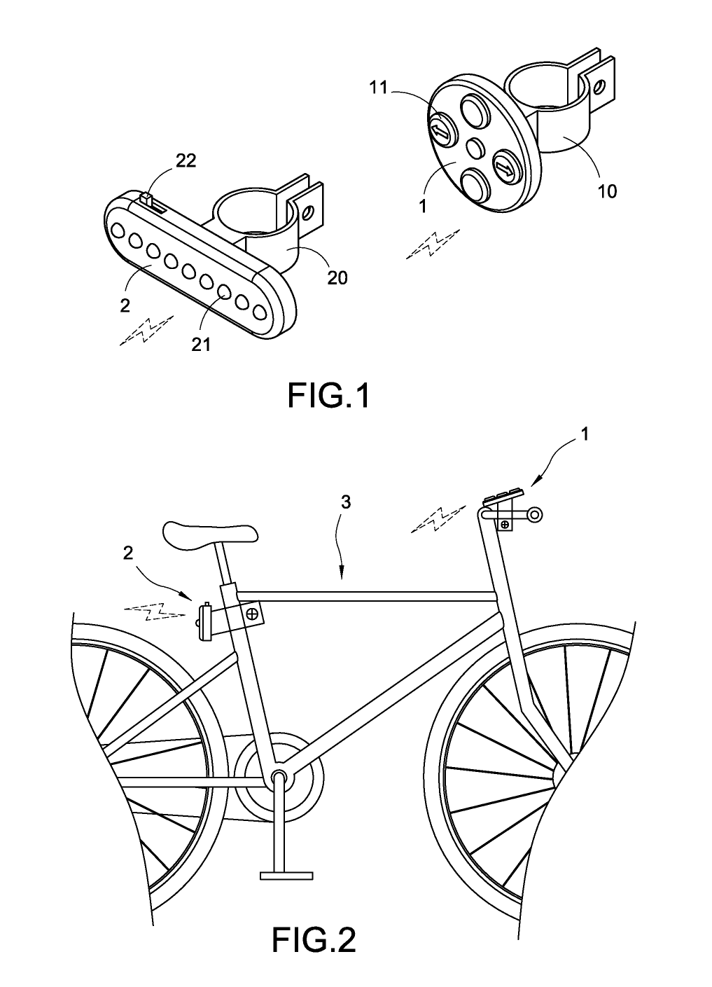

FIG. 1 and FIG. 2 are schematic diagrams of a preferred embodiment according to the present invention before and after installing a wireless control assembly. In the present invention, a bicycle wireless warning system is disclosed. The wireless warning system comprises at least a wireless control module 1 and at least a wireless indicating module 2. As shown in FIG. 1 and FIG. 2, the wireless indicating module 2 has an indicating unit 21 which emits light, and a switch unit 22 for switching the working mode of the wireless indicating module 2. The wireless indicating module 2 is fixed at the back of the body of a bicycles 3 via a fastener 20 and used as a warning light signal.

The wireless control module 1 has at least a control unit 11 for controlling the indicating light signals of indicating unit 21, such as indicating left turn light signals, right turn light signals, brakes light signals etc., and are not limited thereto. In addition, the wireless control module 1 is carried by the biker of the bicycle 3, or is fixed on the handle of the body of the bicycle 3 via a fastener 10. In the embodiment, the control unit 11 and the switch unit 22 are physical pressing buttons or switches. The switch unit 22 is used for switching the working modes of the wireless indicating module 2. The control unit 11 is used for controlling the light signal patterns indicated on the indicating unit 21, but is not limited thereto.

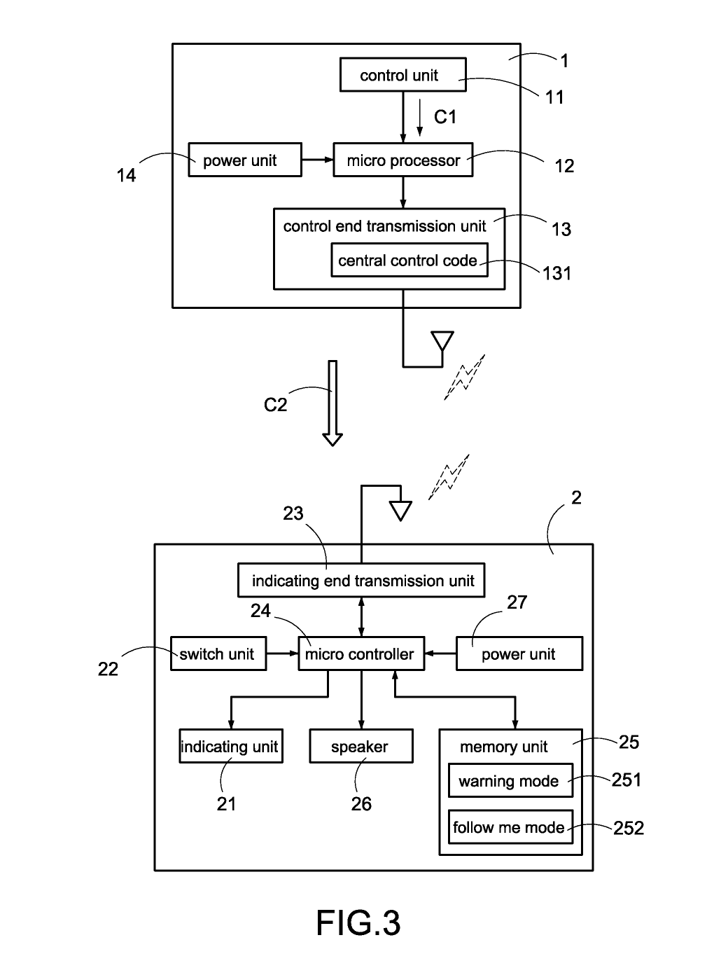

For example, when a biker rides the bicycle 3 with a wireless warning system, the biker switch the mode of the wireless indicating module 2 to a warning module (the warning mode 251 shown in FIG. 3), the biker is allowed to operate on the wireless control module 1 for wireless switching light signals indicated on the wireless indicating module 2. Accordingly, the people around the bicycle 3 are informed of the coming actions of the bicycle 3 such as a left turn, a right turn, braking or other actions which prevent the accidents from occurring by drawing people's attention to the bike coming movement.

FIG. 3 is a block diagram of a wireless control assembly of a preferred embodiment according to the present invention. As shown in the diagram, the wireless control module 1 comprises the control unit 11, the micro processor 12 and a control end transmission unit 13, wherein the micro processor 12 is electrically connected with the control unit 11 and the control end transmission unit 13.

The control unit 11 has a plurality of control buttons, such as a left turn button, a right turn button, a warning button etc. to be operated by users, and generate a switch instruction C1 based on the operations. The micro processor 12 receives the switch instruction C1 generated by the control unit 11, and generates a corresponding control signal C2 based on the switch instruction C1. The control end transmission unit 13 forwards the control signal C2. For example, when the user desires to take a right turn, the user presses the right turn button of the control unit 11 for triggering the control unit 11 to generate the switch instruction C1 indicating a right turn, the micro processor 12 generates the control signal C2 indicating the right turn forwarded via the control end transmission unit 13. When the wireless indicating module 2 receives the control signal C2 based on the switch instruction C1, the wireless indicating module 2 controls the indicating unit 21 to switch into the light signal indicating a right turn based on the content of the control signal C2.

The wireless control module 1 further comprise a power unit 14 electrically connected with the micro processor 12. The power unit 14 can be a battery module or solar cells for providing required power operating the wireless control module 1.

The wireless indicating module 2 comprises the indicating unit 21, the switch unit 22, an indicating end transmission unit 23, a micro controller 24 and a memory unit 25, wherein the micro controller 24 electrically connected with the indicating unit 21, the switch unit 22, the indicating end transmission unit 23 and the memory unit 25.

The wireless indicating module 2 receives the incoming control signal C2 via the indicating end transmission unit 23. The micro controller 24 processes the received control signal C2. The micro controller 24 controls the indicating unit 21 to switch the indicating unit 21 to indicate the corresponding light signals based on the content of the control signal C2, which is the light signal indicating taking a right turn in the above embodiment. In the embodiment, the indicating unit 21 is a Light Emitting Diode (LED) or a Liquid Crystal Display (LCD), but is not limited thereto.

The wireless indicating module 2 further comprises a speaker 26 and a power unit 27, respectively and electrically connected with the micro controller 24. The speaker is used for making corresponding warning sounds based on the content of the control signal C2, to enhance the warning effect along with the indicating unit 21. The power unit 27 can be a battery module or solar cells, for providing power required to operate on the wireless indicating module 2.

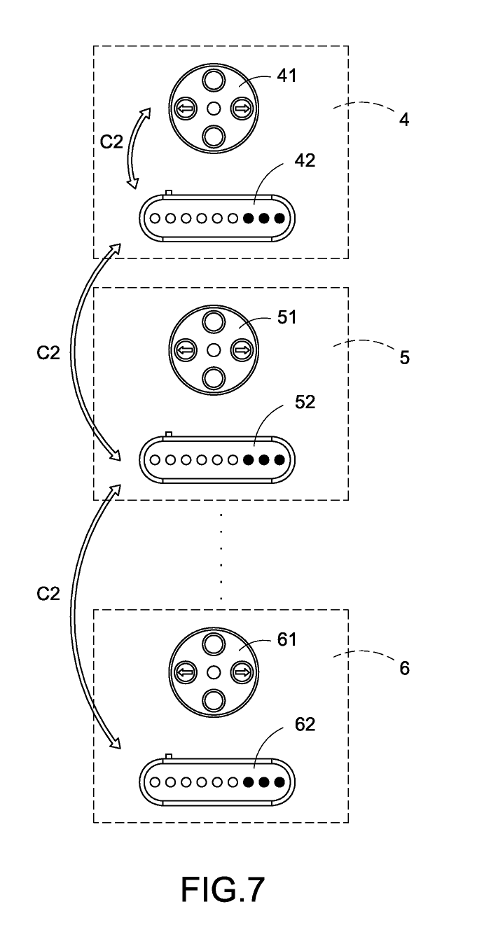

Generally speaking, each wireless display module 2 by default is bundled with a corresponding wireless control module 1. The wireless indicating module 2 and the wireless control module 1 form an independent wireless control assembly (the first wireless control assembly 4 shown in FIG. 7). The memory unit 25 records the warning mode 251 and a follow me mode 252. The user operates on the switch unit 22 to switch the wireless indicating module 2 to work under the warning mode 251 or the follow me mode 252. When the wireless indicating module 2 works under the warning mode 251, the wireless indicating module 2 is controlled by the wireless control module 1 in the same wireless control assembly and not controlled by other wireless control modules.

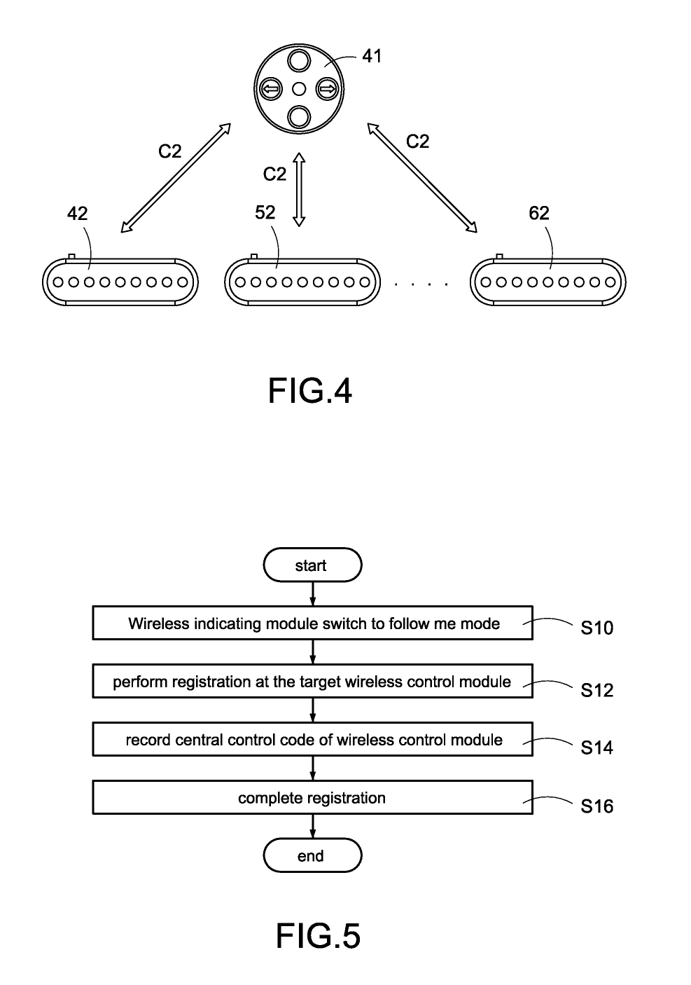

When the wireless indicating module 2 is switched to work under the follow me mode 252, the wireless indicating module 2 is allowed to perform registration at any wireless control module to be controlled by other wireless control module. FIG. 4 is a registration schematic diagram of a preferred embodiment according to the present invention. As shown in FIG. 4, when working under the follow me mode 252, multiple wireless display modules 42, 52, 62 perform registration at the same wireless control module 41, to be simultaneously controlled by the wireless control module 41. In other words, if the wireless warning system has multiple wireless control assembly, as long as all wireless display modules 42, 52, 62 are switched to the follow me mode 252 and perform registration at the wireless control module 41, the wireless control module 41 alone is able to simultaneously control all wireless display modules 42, 52, 62 in the system.

Back to FIG. 3, the wireless control module 1 has a central control code 131, which is recorded in the control end transmission unit 13, but is not limited thereto. If the wireless indicating module 2 and the wireless control module 1 are not in the same wireless control assembly, before the wireless indicating module 2 is controlled by the wireless control module 1, the wireless indicating module 2 has to switch to work under the follow me mode 252, and performs registration at the wireless control module 1. Upon the registration is completed, the wireless indicating module 2 records the central control code 131 of the wireless control module 1. Further, when the indicating end transmission unit 23 receives the incoming control signal C2, the micro controller 24 determines whether the control signal C2 is in accordance (matched) with the central control code 131 recorded and controls the indicating unit 21 to switch light signals based on the content of the control signal C2 after the match is confirmed. Furthermore, the micro controller 24 controls the indicating end transmission unit 23 to forward the control signal C2.

As mentioned above, in the present invention, as long as the control signal C2 is in accordance with the central control code 131 recorded in the wireless indicating module 2, the control signal C2 is accepted by the wireless indicating module 2. However, the control signal C2 may not be directly sent by the wireless control module 1. In the embodiment, the control end transmission unit 13 and the indicating end transmission unit 23 are Radio Frequency (RF) transmitting units. According to the field tests, the transmission distance is optimized at 50 meters. When the distance between the wireless indicating module 2 and the wireless control module 1 is more than 50 meters, the wireless indicating module 2 cannot directly receive the control signal C2 sent by the wireless control module 1.

The present invention is characterized by that the wireless warning system has multiple wireless indicating modules 2 (for example installed in several bicycles). When a wireless indicating module 2 receives the control signal C2, the wireless indicating module 2 forwards the control signal C2 from itself, the center, to a radius of 50 meters outbound, aiming to arrive to the other wireless display modules in the neighborhood of the wireless indicating module. In other words, forwarding the control signal C2 via the wireless indicating module 2 can effectively expand the transmission distance of the control signal C2.

FIG. 5 is a registration flow chart of a preferred embodiment according to the present invention. First, the user switches the wireless indicating module 2 to work under the follow me mode 252 (step S10). In addition, the wireless indicating module 2 performs registration at the target wireless control module 1 (step S12). Thus, the wireless indicating module 2 records the central control code 131 of the wireless control module 1 where the registration is performed (step S14), and completes the registration (step S16).

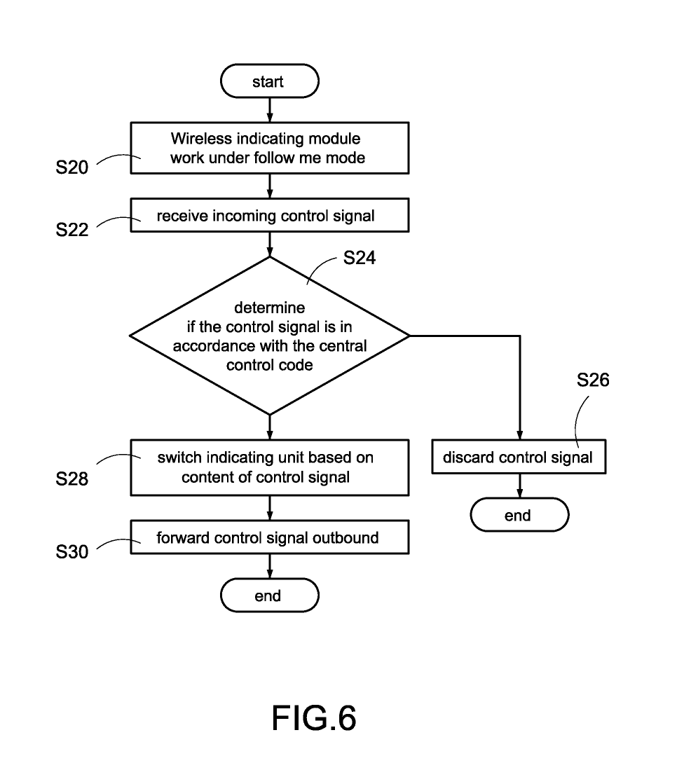

FIG. 6 is a control flow chart of a preferred embodiment according to the present invention. First, the wireless indicating module 2 to be controlled has to keep working under the follow me mode 252 (step S20). The wireless indicating module 2 receives the incoming control signal C2 (step S22). The wireless indicating module 2 determines if the control signal C2 is in accordance with the central control code 131 recorded via the micro controller 24, (step S24). If not, the wireless indicating module 2 discards the control signal C2 (step S26), the indicating unit 21 and/or the speaker 26 does not perform any switching action.

If the micro controller 24 determines that the control signal C2 is in accordance with the central control code 131, the micro controller 24 controls the indicating unit 21 to switch light signals based on the content of the control signal C2 (step S28) and controls the indicating end transmission unit 23 to forward the control signal C2 outbound (step S30). Thus, other devices, which are away from the wireless control module 1 but within the transmission distance of the wireless indicating module 2, are able to receive the control signal C2.

FIG. 7 is a schematic diagram for forwarding control signals of a preferred embodiment according to the present invention. As mentioned above, each wireless display module by default is bundled with a corresponding wireless control module. As shown in FIG. 7, the wireless control module 41 and the wireless indicating module 42 form a first wireless control assembly 4; a wireless control module 51 and the wireless indicating module 52 form a second wireless control assembly 5; and a wireless control module 61 and the wireless indicating module 62 form a third wireless control assembly 6. In the embodiment, the wireless warning system comprises the three exemplary wireless control assemblies 4, 5, 6, but the quantity is not limited to three and is not limited thereto.

When working under the warning mode 251, the wireless indicating module 42 is only controlled by the wireless control module 41; the wireless indicating module 52 is only controlled by the wireless control module 51; and the wireless indicating module 62 is only controlled by the wireless control module 61.

When working under the follow me mode 252, these wireless display modules 42, 52, 62 perform registration on any wireless control modules 41, 51, 61 (the wireless control module 41 performs the registration in the example below), to be under control of the wireless control module 41. Under the circumstance, the wireless control modules 51, 61 do not function, and do not control these wireless display modules 42, 52, 62. The wireless control module 41 where the registration is performed simultaneously control these wireless display modules 42, 52, 62. Typically, the wireless control module 41 is for example installed on the leading bicycle of the bicycle team, and controlled by the biker of the leading bicycle.

As shown in the diagram, the wireless indicating modules 52, 62 are away from the wireless control module 41, providing that the wireless indicating modules 52, 62 are unable to directly receive the control signal C2 sent by the wireless control module 41, the wireless indicating module 42 receives and forwards the control signal C2 for expanding the transmission distance of the control signal C2. As shown in the diagram, the wireless indicating module 42 directly receives the control signal C2 sent by the wireless control module 41, the wireless indicating module 52 receives the control signal C2 forwarded by the wireless indicating module 42, the wireless indicating module 62 at the longest distance receives the control signal C2 forwarded by the wireless indicating module 52 in front of the wireless indicating module 62. Thus, when a bicycle team uses the wireless warning system of the present invention, the transmission distance of the control signal C2 is effectively expanded and the length of the bike team is not limited accordingly.

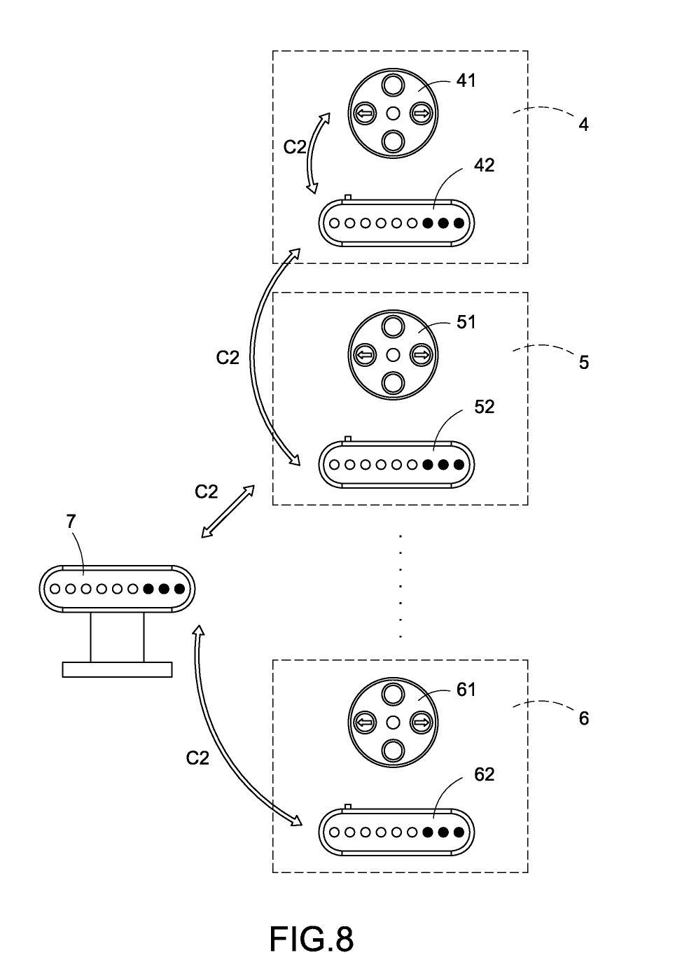

FIG. 8 is a schematic diagram for forwarding control signals of the other preferred embodiment according to the present invention. In the example of a bicycle team, the physical strength and the biking speed of each biker differ. When a biker (for example the biker using the wireless indicating module 62) left behind the bike team by a distance, the wireless indicating module 62 may simultaneously fail to receive the control signal C2 sent by the wireless control module 41, and fails to receive the control signal C2 forwarded by the wireless indicating module 42, 52 ahead. In the embodiment, the wireless warning system can further comprise a fixed wireless indicating module 7.

The fixed wireless indicating module 7 performs registration at the wireless control module 41 at the wireless control module 41 of the leading bicycle before the team setting off, and installed by a road corner of the biking paths. The fixed wireless indicating module 7 receives and forwards the control signal C2 sent by the wireless control module 41. For example, when the leading bicycle rides through the road corner and sends the control signal C2 indicating a right turn, the fixed wireless indicating module 7 receives the control signal C2 and controls the indicating unit to switch to the right turn light signal, whilst forwards the control signal C2 outbound.

When a biker of the bicycle left behind rides through the road corner without knowing to take a left turn or a right turn, the biker is informed by the indicating unit of the fixed wireless indicating module 7 of the turning direction took by the bicycle team ahead and accordingly does not get lost. In addition the wireless indicating module 62 also receives the control signal C2 forwarded by the fixed wireless indicating module 7 for controlling the indicating unit to switch to right turn light signal, whilst forwards the control signal C2. As s result, if there are other bicycles left behind, these bicycles are able to receive related information from the wireless indicating module 62 and/or the fixed wireless indicating module 7.

As the skilled person will appreciate, various changes and modifications can be made to the described embodiments. It is intended to include all such variations, modifications and equivalents which fall within the scope of the invention, as defined in the accompanying claims.

What is claimed is:

1. A bicycle wireless indicating module, comprising:
an indicating end transmission unit, for receiving an incoming control signal;
a micro controller, electrically connected with the indicating end transmission unit, for processing the control signal; and
an indicating unit, electrically connected with the micro controller, controlled by the micro controller;
wherein, the wireless indicating module performs registration at a wireless control module, and records a central control code of the wireless control module, the micro controller determines whether the control signal is in accordance with the central control code, after ensuring the accordance, the micro controller controls the indicating unit to perform content switching based on the content of the control signal, and controls the indicating end transmission unit to outbound forwarding the control signal, wherein the control signals received by the indicating end transmission unit are directly sent by the wireless control module, or forwarded by other wireless indicating module.

2. The wireless indicating module of claim 1, wherein the indicating end transmission unit is a Radio Frequency (RF) transmitting unit.

3. The wireless indicating module of claim 2, wherein the wireless indicating module further comprises:
a memory unit, electrically connected with the micro controller, the memory unit records a warning mode and a follow me mode;
a switch unit, electrically connected with the micro controller, for switching operating modes between the warning mode and the follow me mode at the wireless indicating module;
wherein, when the wireless indicating module operates under the follow me mode, the wireless indicating module perform registration at the wireless control module, records the central control code of the wireless control module where the registration is performed, and performs matching of the received control signal.

4. The wireless indicating module of claim 3, wherein the wireless indicating module further comprises:
a speaker, electrically connected with the micro controller, and making corresponding warning sounds based on the content of the control signal; and
a power unit, electrically connected with the micro controller, for providing power required to operate on the wireless indicating module.

5. The wireless indicating module of claim 3, wherein the indicating unit is a Light Emitting Diode (LED) or a Liquid Crystal Display (LCD).

6. A bicycle wireless warning system, comprising:
at least a wireless indicating module, comprising:
an indicating end transmission unit, for receiving incoming control signals;
a micro controller, electrically connected with the indicating end transmission unit, for processing the received control signals; and
an indicating unit, electrically connected with the micro controller, controlled by the micro controller;
a wireless control module, for performing registration of the wireless indicating module, comprising:
a control unit, for receiving external commands to generate a switch instruction;
a micro processor, electrically connected with the control unit for generating corresponding control signals based on the switch instructions; and
a control end transmission unit, electrically connected with the micro processor, for sending outbound control signals;
wherein, after the registration completes, at least a wireless indicating module records a central control code of the wireless control module, the wireless indicating module receives the control signals, the micro controller determines whether the control signal is in accordance with the central control code, after ensuring the accordance, the micro controller controls the indicating unit to perform content switching based on the content of the control signal, and controls the indicating end transmission unit to outbound forwarding the control signal.

7. The wireless indicating module of claim 6, wherein the control signal received by at least a wireless indicating module is directly sent by the wireless control module, or forwarded by the other wireless indicating modules.

8. The wireless indicating module of claim 7, wherein the indicating end transmission unit and the control end transmission unit is a Radio Frequency (RF) transmitting unit.

9. The wireless indicating module of claim 8, wherein at least a wireless indicating module further comprising:
a memory unit, electrically connected with the micro controller, the memory unit records a warning mode and a follow me mode;
a switch unit, electrically connected with the micro controller, for switching operating modes between the warning mode and the follow me mode at the wireless indicating module;
wherein, when the wireless indicating module operates under the follow me mode, the wireless indicating module perform registration at the wireless control module, records the central control code of the wireless control module where the registration is performed, and performs matching of the received control signal.

10. The wireless indicating module of claim 8, wherein the indicating unit is a Light Emitting Diode, LED) or a Liquid Crystal Display (LCD).

11. The wireless indicating module of claim 8, wherein at least a wireless indicating module is installed on a bicycle, or installed on the road corners of the paths the bicycle passing by.
